(19) United States
(12) Patent Application Publication
(10) Pub. No.: US 2023/0038372 A1
(43) Pub. Date: Feb. 9, 2023

(54) VEHICLE TO VEHICLE COMMUNICATION CONTROL FOR VEHICLES IN A PLATOON

(71) Applicant: QUALCOMM Incorporated, San Diego, CA (US)

(72) Inventors: Lan YU, Beijing (CN); Hong CHENG, Basking Ridge, NJ (US); Dan VASSILOVSKI, Del Mar, CA (US); Gene Wesley MARSH, San Diego, CA (US)

(21) Appl. No.: 17/758,785

(22) PCT Filed: Feb. 7, 2020
(86) PCT No.: PCT/CN2020/074502

§ 371 Date: Jul. 13, 2022

(51) Int. Cl. G08G 1/00; G05D 1/02; H04W 4/46

(52) U.S. Cl. CPC G08G 1/22; G05D 1/0293; G05D 1/0295; H04W 4/46; G05D 2201/0213

(57) ABSTRACT

Various aspects of the present disclosure generally relate to sensor systems. In some aspects, a method may include determining a classification of a first vehicle of a plurality of vehicles traveling in a platoon. The method may include causing, based at least in part on the classification, the first vehicle to share sensor data with a second vehicle in the platoon according to a sensor data sharing profile, wherein the sensor data is associated with a sensor system of the first vehicle. Numerous other aspects are provided.

### FIELD OF THE DISCLOSURE

Aspects of the present disclosure generally relate to vehicle sensors, and more particularly to a sensor data sharing system for sharing sensor data between vehicles.

### BACKGROUND

A vehicle may include a sensor system that includes one or more sensors to determine characteristics associated with the vehicle and/or characteristics associated with an environment of the vehicle. For example, such a sensor system may be configured to detect proximity to an object, a weather condition, a road condition, a vehicle speed, a traffic condition, a location of the vehicle, and/or the like.

### SUMMARY

In some aspects, a method, performed by a device, may include determining a classification of a first vehicle of a plurality of vehicles traveling in a platoon; and causing, based at least in part on the classification, the first vehicle to share sensor data with a second vehicle in the platoon according to a sensor data sharing profile, wherein the sensor data is associated with a sensor system of the first vehicle.

In some aspects, a device may include a memory and one or more processors operatively coupled to the memory. The memory and the one or more processors may be configured to determine a classification of a first vehicle of a plurality of vehicles traveling in a platoon; and cause, based at least in part on the classification, the first vehicle to share sensor data with a second vehicle in the platoon according to a sensor data sharing profile, wherein the sensor data is associated with a sensor system of the first vehicle.

In some aspects, a non-transitory computer-readable medium may store one or more instructions. The one or more instructions, when executed by one or more processors of a device, may cause the one or more processors to receive, from a master vehicle that is traveling in a platoon, a classification identifier; share sensor data, associated with a sensor system, with one or more vehicles in the platoon according to a sensor data sharing profile that is associated with the classification identifier; detect a characteristic associated with the platoon; and override a parameter associated with the sensor data sharing profile to adjust sensor data sharing with the one or more vehicles.

In some aspects, an apparatus for wireless communication may include means for receiving, from a master vehicle that is traveling in a platoon, a classification identifier; means for sharing sensor data, associated with a sensor system, with one or more vehicles in the platoon according to a sensor data sharing profile that is associated with the classification identifier; means for detecting a characteristic associated with the platoon; and means for overriding a parameter associated with the sensor data sharing profile to adjust sensor data sharing with the one or more vehicles.

Aspects generally include a method, apparatus, system, computer program product, non-transitory computer-readable medium, user device, wireless communication device, and processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram conceptually illustrating an example environment in which a sensor data sharing system described herein may be implemented, in accordance with various aspects of the present disclosure.

FIG. 2 is a diagram conceptually illustrating example components of one or more devices shown in FIG. 1, in accordance with various aspects of the present disclosure.

FIGS. 3-5 are diagrams conceptually illustrating examples associated with sensor data sharing between vehicles in accordance with various aspects of the present disclosure.

FIGS. 6 and 7 are flowcharts of example processes for sensor data sharing between vehicles.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based at least in part on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

In some instances, vehicles (e.g., via electronic control units (ECUs) of vehicles) may be configured to communicate with each other. For example, advances in communication technologies have enabled vehicle-to-vehicle (V2V) communication. Furthermore, one or more roadside units (RSUs) of a roadside platform may be configured to facilitate communication between vehicles, receive information associated with and/or from vehicles traveling along a roadway, provide information to and/or associated with vehicles traveling along a roadway, and/or the like. In such cases, vehicles may be configured to share sensor data that is generated by sensors onboard the respective vehicles. For example, a first vehicle may share sensor data with a second vehicle to enable the second vehicle to determine characteristics of an environment of the first vehicle (e.g., an environment surrounding the second vehicle), a speed of the first vehicle, a location of the first vehicle, and/or the like. In this way, the second vehicle may be able to determine a position of the first vehicle relative to the second vehicle, may be able to detect an object near the first vehicle that cannot be sensed by a sensor system of the second vehicle (e.g., due to the object being in a blind spot of the sensor system, due to the second vehicle being out of range of the object, and/or the like), may be able to detect road hazards (e.g., potholes) that cannot be sensed by the sensor system of the second vehicle, and/or the like.

In some instances, a plurality of vehicles that are traveling together on a roadway (referred to herein as a “platoon”) may communicate with one another to share information associated with each of the vehicles within the platoon. The platoon of vehicles may be formed through a series of communications that designates communication parameters for communicating with one another (e.g., via V2V communications) and/or RSUs while traveling within the platoon. In such instances, the vehicles in the platoon may often share sensor data associated with a same object (e.g., a same detected obstruction or vehicle that is not within the platoon), a same characteristic of the platoon (e.g., a speed of the platoon, a location of the platoon, and/or the like), and/or the like. Accordingly, such sensor data is redundant and is a waste of computing resources (e.g., processing resources and/or memory resources used to generate and/or process communications between the vehicles of the platoon) and/or communication resources (e.g., used to transmit or receive the redundant sensor data).

Moreover, some sensor data for determining certain information about the platoon (or an environment of the platoon) can be more valuable (e.g. more accurate, more relative, and/or the like) from one of the vehicles of the platoon than another vehicle of the platoon. For example, a last vehicle at the back of the platoon can provide more valuable sensor data associated with an environment behind the platoon than a middle positioned vehicle that is not at the back of the platoon, because the middle positioned vehicle that is not at the back of the platoon has another vehicle (including the last vehicle) behind the middle positioned vehicle. In such a case, the middle positioned vehicle would waste resources associated with the environment sensed behind the middle positioned vehicle because the last vehicle is detecting more accurate information regarding the environment behind the platoon (because the last vehicle is not blocked by other vehicles in the platoon).

According to some aspects described herein, a sensor data sharing system reduces redundant sharing of sensor data (e.g., via V2V communications, via a roadside platform, and/or the like) between vehicles in a platoon according to characteristics of the platoon and/or the individual vehicles in the platoon. For example, a master vehicle of the platoon (e.g., the ECU of the master vehicle) may receive information associated with a member vehicle of the platoon and/or a sensor system of the member vehicle and determine a sensor data sharing profile for the member vehicle according to a classification of the member vehicle that is based at least in part on the information. The sensor data sharing profile may specify a frequency with which the member vehicle is to share sensor data (including specific types of sensor), may specify which types of sensor data is to be shared (or not shared) by the member vehicle, which types of information are to be shared (or not shared) by the member vehicle, and/or the like. In this way, the master vehicle can reduce the amount of redundant sensor data and/or redundant V2V communications that are shared throughout the platoon of vehicles.

As another example, a member vehicle may independently monitor and/or detect when the member vehicle is transmitting and/or receiving redundant communications. For example, despite being configured to share sensor data according to a sensor data sharing profile provided by a master vehicle of the platoon, the member vehicle may override certain parameters, associated with sharing sensor data, that are specified in the sensor sharing profile to reduce redundancy associated with the sensor data.

As described herein, reducing the amount of redundantly generated, provided, and/or processed sensor data frees computing resources, communication resources, power resources, and/or the like of the individual vehicles of the platoon. The increase in available resources can allow the vehicles to perform other processes, receive and/or transmit urgent communications, process and/or detect other information associated with the individual vehicles and/or platoon, and/or the like that otherwise could not be performed using the examples described herein. Correspondingly, such processes, communications, and/or information can further provide benefits including improved safety, improved data processing performance (e.g., improved speeds), improved communication performance (e.g., improved reliability, reduced latency, and/or the like), and/or the like.

According to some aspects described herein, a sensor data sharing system may be configured within one or more ECUs of one or more vehicles of a platoon (e.g., as respective onboard systems) and/or within one or more RSUs of a roadside platform that can be communicatively coupled with the vehicle.

In this way, the sensor data sharing system may determine reliability of sensor data generated by a sensor system of a vehicle. Accordingly, the sensor data sharing system may detect unreliable sensor data associated with the sensor system and prevent the vehicle from using and/or sharing the unreliable sensor data. Additionally, or alternatively, a sensor data sharing system may compare reliability of received sensor data from another vehicle with sensor data generated onboard the vehicle and use the sensor data that is determined to be more reliable. In this way, the sensor data sharing system may ensure that sensor data shared with a vehicle and/or used by the vehicle is the most reliable sensor data available to the vehicle, thus increasing the likelihood that an ECU of the vehicle can most accurately determine a characteristic of the vehicle (e.g., a speed of the vehicle, a proximity of the vehicle to an object, and/or the like), a characteristic of an environment of the vehicle (e.g., a weather condition, a distance to a particular location or object, and/or the like), and/or the like. Furthermore, if sensor data is determined to be unreliable, the sensor data sharing system may prevent the sensor data from being shared, thus avoiding and/or preventing the waste of resources (e.g., computing resources, network resources, and/or the like) associated with sharing unreliable sensor data that should not be used by a receiving vehicle.

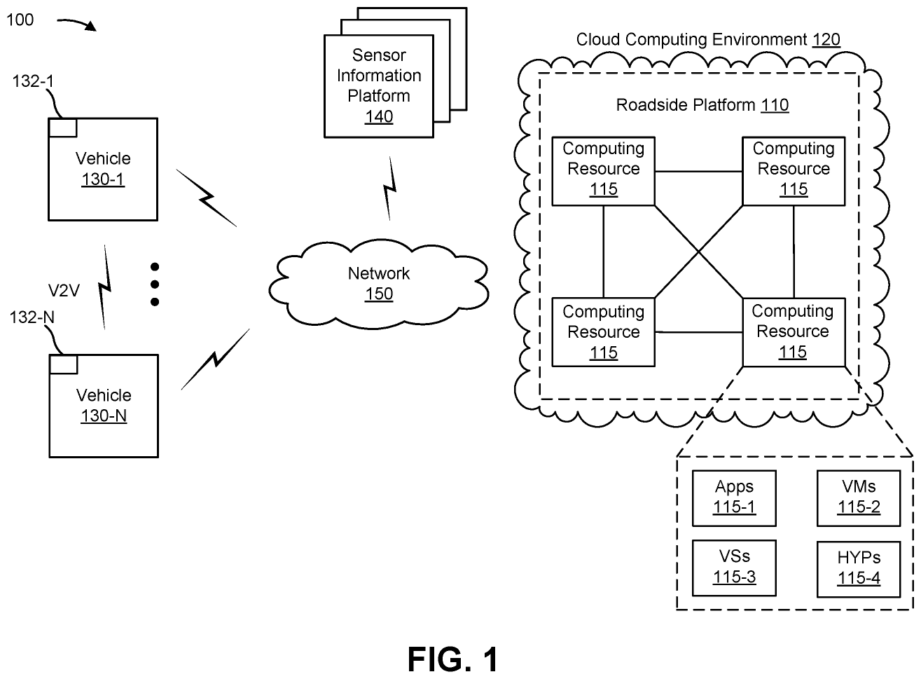

FIG. 1 is a diagram of an example environment 100 in which systems and/or methods described herein may be implemented. As shown in FIG. 1, environment 100 may include a roadside platform 110 hosted via one or more computing resources 115 (referred to individually as a “computing resource 115” and collectively as “computing resources”) of a cloud computing environment 120, one or more vehicles 130-1 to 130-N (referred to individually as a “vehicle 130” and collectively as “vehicles 130”) with corresponding ECUs 132-1 to 132-N (referred to individually as a “ECU 132” and collectively as “ECUs 132”), one or more sensor information platforms (referred to individually as a “sensor information platform 140” and collectively as “sensor information platforms 140”), and a network 150. Although each of vehicles 130 are shown in FIG. 1 with one corresponding ECU 132 (e.g., the ECU 132 is collocated with the vehicle), one or more vehicles 130 in environment 100 may include one or more ECUs 132. Devices of environment 100 may interconnect via wired connections, wireless connections, or a combination of wired and wireless connections. As described herein, a sensor data sharing system is included in at least one of roadside platform 110 and/or one or more ECUs 132.

Roadside platform 110 includes one or more computing resources assigned to receive, generate, process, and/or provide information associated with sensor data sharing, as described herein. For example, roadside platform 110 may be a platform implemented by cloud computing environment 120 that may receive sensor information associated with sensors of vehicles 130, determine classifications of vehicles 130 and/or sensor data sharing profiles for vehicles 130 based at least in part on vehicles 130 being within a platoon. In some aspects, roadside platform 110 is implemented by computing resources 115 of cloud computing environment 120.

Roadside platform 110 may include a server device or a group of server devices. For example, roadside platform 110 may include one or more roadside units that include one or more server devices. Such roadside units may be configured along a roadway to permit communication with ECUs 132 of vehicles 130. In some aspects, roadside platform 110 may be hosted in cloud computing environment 120. Notably, while aspects described herein may describe roadside platform 110 as being hosted in cloud computing environment 120, in some aspects, roadside platform 110 may be non-cloud-based or may be partially cloud-based.

Cloud computing environment 120 includes an environment that delivers computing as a service, whereby shared resources, services, and/or the like may be provided to ECUs 132 of vehicles 130. Cloud computing environment 120 may provide computation, software, data access, storage, and/or other services that do not require end-user knowledge of a physical location and configuration of a system and/or a device that delivers the services. As shown, cloud computing environment 120 may include computing resources 115. Computing resources 115 may correspond to roadside units of roadside platform 110, as described herein. Computing resources 115 may be configured to form at least part of a sensor data sharing system, as described herein. Accordingly, computing resources 115 of roadside platform 110 may permit one or more capabilities of a sensor data sharing system to be supported in cloud computing environment 120.

Computing resource 115 includes one or more computers, server devices, or another type of computation and/or communication device. In some aspects, computing resource 115 may host roadside platform 110. The cloud resources may include compute instances executing in computing resource 115, storage devices provided in computing resource 115, data transfer devices provided by computing resource 115, and/or the like. In some aspects, computing resource 115 may communicate with other computing resources 115 via wired connections, wireless connections, or a combination of wired and wireless connections.

As further shown in FIG. 1, computing resource 115 may include a group of cloud resources, such as one or more applications (“APPs”) 115-1, one or more virtual machines (“VMs”) 115-2, virtualized storage (“VSs”) 115-3, one or more hypervisors (“HYPs”) 115-4, or the like.

Application 115-1 includes one or more software applications (e.g., software applications associated with a sensor data sharing system) that may be provided to or accessed by ECU 132. Application 115-1 may eliminate a need to install and execute the software applications on ECU 132. For example, application 115-1 may include software associated with roadside platform 110 and/or any other software capable of being provided via cloud computing environment 120. In some aspects, one application 115-1 may send/receive information to/from one or more other applications 115-1, via virtual machine 115-2.

Virtual machine 115-2 includes a software aspect of a machine (e.g., a computer) that executes programs like a physical machine. Virtual machine 115-2 may be either a system virtual machine or a process virtual machine, depending upon use and degree of correspondence to any real machine by virtual machine 115-2. A system virtual machine may provide a complete system platform that supports execution of a complete operating system (“OS”). A process virtual machine may execute a single program and may support a single process. In some aspects, virtual machine 115-2 may execute on behalf of a user (e.g., a user associated with vehicle 130), and may manage infrastructure of cloud computing environment 120, such as data management, synchronization, or long-duration data transfers.

Virtualized storage 115-3 includes one or more storage systems and/or one or more devices that use virtualization techniques within the storage systems or devices of computing resource 115. In some aspects, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations. In some aspects, virtualized storage 115-3 may store information associated with one or more sensor systems of one or more of vehicles 130 to permit a sensor data sharing system to determine a classification of vehicles 130 and/or sensor data sharing profiles for the vehicles 130.

Hypervisor 115-4 provides hardware virtualization techniques that allow multiple operating systems (e.g., “guest operating systems”) to execute concurrently on a host computer, such as computing resource 115. Hypervisor 115-4 may present a virtual operating platform to the guest operating systems and may manage the execution of the guest operating systems. Multiple instances of a variety of operating systems may share virtualized hardware resources.

Vehicle 130 may include any vehicle that includes a sensor system as described herein. For example, vehicle 130 may be a consumer vehicle, an industrial vehicle, a commercial vehicle, and/or the like. Vehicle 130 may be capable of traveling and/or providing transportation via public roadways, may be capable of use in operations associated with a worksite (e.g., a construction site), and/or the like.

According to aspects described herein, two or more of vehicles 130 may travel in a platoon. As an example, five vehicles 130-1 to 130-5 may be designated as a platoon according to any suitable techniques. The platoon of vehicles 130-1 to 130-5 may be manually configured by a user. Additionally, or alternatively the platoon may be dynamically configured by one or more of the five vehicles 130-1 to 130-5. In such a case, based at least in part on the one or more of the five vehicles determining, from V2V communications with one another that the five vehicles are traveling in a same direction, at relatively the same speed, and within a threshold distance of at least one of the other vehicles. Further, a first vehicle 130-1 in the platoon may be designated as a master vehicle that is to configure communication settings of the platoon of vehicles 130-1 to 130-5, including the remaining member vehicles 130-2 to 130-5. Selection of the master vehicle for the platoon can be determined according to any suitable technique (e.g., based at least in part on position in the platoon, based at least in part on sensor capabilities of the master vehicles, based at least in part on communication capabilities of the master vehicle, based at least in part on processing capabilities of the master vehicle, and/or the like).

A vehicle 130 may be controlled by ECU 132 may include one or more devices capable of receiving, generating, storing, processing, and/or providing information associated with sensor sharing and/or a sensor data sharing system described herein. For example, ECU 132 may include a communication and/or computing device, such as an onboard computer, a control console, an operator station, or a similar type of device. In some aspects, ECU 132 may include and/or be used to implement a sensor data sharing system, as described herein. For example, the ECU 132 may permit the vehicle 130 to have one or more onboard capabilities associated with a sensor data sharing system (e.g., determining characteristics of other vehicles 130, determining classifications of other vehicles 130, processing sensor data from other vehicles 130, determining whether to use shared sensor data from other vehicles 130, determining whether to share sensor data with other vehicles 130, providing sensor data information to another vehicle 130 or to roadside platform 110, and/or the like).

Sensor information platform 140 includes one or more devices capable of storing, processing, and/or routing information associated with sensor systems of one or more of vehicles 130 and/or one or more vehicles representative of vehicles 130. In some aspects, sensor information platform 140 may include a communication interface that allows sensor information platform 140 to receive information from and/or transmit information to other devices in environment 100.

Sensor information platform 140 may include one or more online or web-based platforms associated with a third-party entity. Such a third-party entity may not be associated with one or more entities that are associated with vehicles 130 (e.g., owners of vehicles 130, operators of vehicles 130, manufacturers of vehicles 130, distributors of vehicles 130, and/or the like). For example, such a third-party entity may be a trusted entity that performs one or more services associated with determining classifications of vehicles according to characteristics of vehicles 130 (e.g., sensing capabilities sensors on vehicles 130, sensor configurations of vehicles 130, types of sensors on vehicles 130, and/or the like). Sensor information platform 140 may provide information (e.g., information corresponding to the classifications and/or corresponding sensor data sharing profiles for the classifications) associated with vehicles 130 to roadside platform 110 and/or to ECUs 132. In some aspects, sensor information platform 140 and roadside platform 110 may be associated with (e.g., owned by, operated by, managed by, and/or the like) a same entity.

Network 150 includes one or more wired and/or wireless networks. For example, network 150 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 1 are provided as one or more examples. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

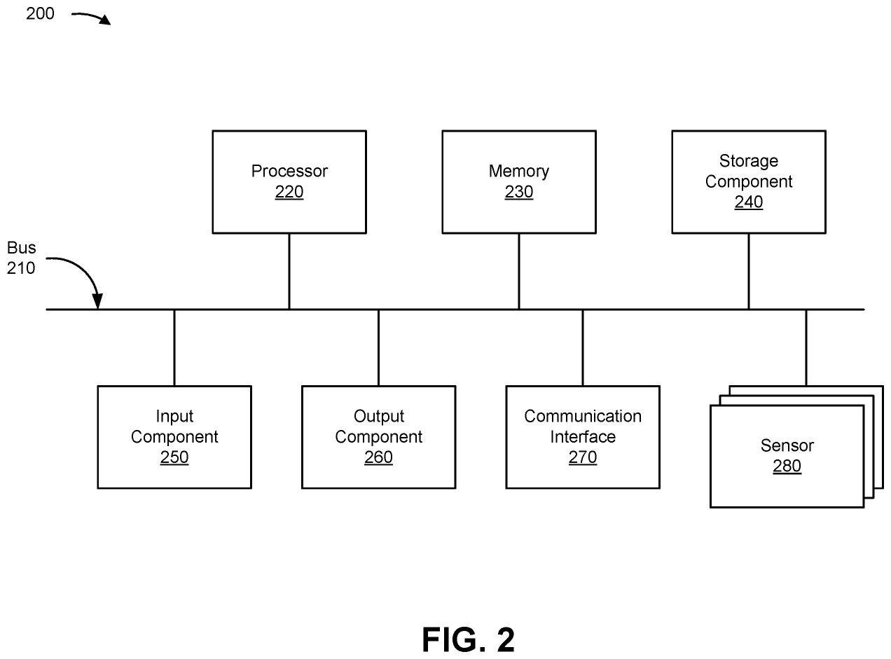

FIG. 2 is a diagram of example components of a device 200. Device 200 may correspond to roadside platform 110, computing resource 115, ECU 132, sensor information platform 140, and/or the like. In some aspects, roadside platform 110, computing resource 115, ECU 132, and/or sensor information platform 140 may include one or more devices 200 and/or one or more components of device 200. As shown in FIG. 2, device 200 may include a bus 210, a processor 220, a memory 230, a storage component 240, an input component 250, an output component 260, a communication interface 270, and one or more sensors 280 (referred to individually as a “sensor 280” and collectively as “sensors 280”).

Bus 210 includes a component that permits communication among multiple components of device 200. Processor 220 is implemented in hardware, firmware, and/or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 220 includes one or more processors capable of being programmed to perform a function. Memory 230 includes a random access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of device 200. For example, storage component 240 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 250 includes a component that permits device 200 to receive information, such as via user input (e.g., a touch screen display, a keyboard, a keypad, a mouse, a button, a switch, and/or a microphone). Additionally, or alternatively, input component 250 may include a component for determining location (e.g., a global positioning system (GPS) component) and/or a sensor (e.g., an accelerometer, a gyroscope, an actuator, another type of positional or environmental sensor, and/or the like). Output component 260 includes a component that provides output information from device 200 (via, e.g., a display, a speaker, a haptic feedback component, an audio or visual indicator, and/or the like).

Communication interface 270 includes a transceiver-like component (e.g., a transceiver, a separate receiver, a separate transmitter, and/or the like) that enables device 200 to communicate with other devices, such as via a wired connection, a wireless connection, or a combination of wired and wireless connections. Communication interface 270 may permit device 200 to receive information from another device and/or provide information to another device. For example, communication interface 270 may include an Ethernet interface, an optical interface, a coaxial interface, an infrared interface, a radio frequency (RF) interface, a universal serial bus (USB) interface, a Wi-Fi interface, a cellular network interface, and/or the like.

Device 200 may perform one or more processes described herein. Device 200 may perform these processes based at least in part on processor 220 executing software instructions stored by a non-transitory computer-readable medium, such as memory 230 and/or storage component 240. As used herein, the term “computer-readable medium” refers to a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may cause processor 220 to perform one or more processes described herein. Additionally, or alternatively, hardware circuitry may be used in place of or in combination with software instructions to perform one or more processes described herein. Thus, aspects described herein are not limited to any specific combination of hardware circuitry and software.

Sensor 280 may include one or more devices capable of sensing one or more characteristics of an environment of device 200. For example, sensors 280 may include one or more of a camera, a light detection and ranging (LIDAR) sensor, a radio detection and ranging (RADAR) sensor, and/or the like. Accordingly, sensors 280 may include any suitable sensors that may be configured within a sensor system to perform one or more operations, generate sensor data to permit one or more operations to be performed, and/or the like. For example, sensors 280 may be configured within a sensor system to detect the presence of one or more objects in an environment of device 200, detect a proximity to one or more objects in the environment of device 200, determine a location of device 200, determine a speed associated with a device 200, and/or the like. As described herein, sensor data generated by sensors 280 may be communicated (e.g., via communication interface 270) to another device to permit the sensor data to be used by the other device to perform one or more operations.

Additionally, or alternatively, sensor 280 may include a magnetometer (e.g., a Hall effect sensor, an anisotropic magnetoresistive (AMR) sensor, a giant magneto-resistive sensor (GMR), and/or the like), a location sensor (e.g., a global positioning system (GPS) receiver, a local positioning system (LPS) device (e.g., that uses triangulation, multi-lateration, etc.), and/or the like), a gyroscope (e.g., a micro-electro-mechanical systems (MEMS) gyroscope or a similar type of device), an accelerometer, a speed sensor, a motion sensor, an infrared sensor, a temperature sensor, a pressure sensor, and/or the like.

In some aspects, device 200 includes means for performing one or more processes described herein and/or means for performing one or more operations of the processes described herein. For example, the means for performing the processes and/or operations described herein may include bus 210, processor 220, memory 230, storage component 240, input component 250, output component 260, communication interface 270, sensors 280, and/or any combination thereof

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

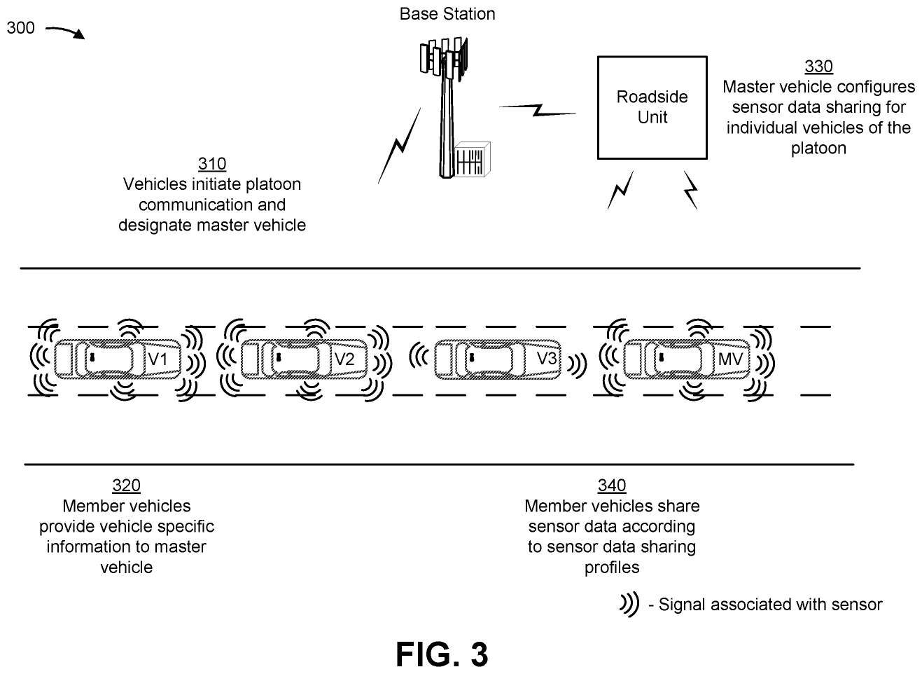

FIG. 3 is a diagram conceptually illustrating an example 300 associated with sensor data sharing between vehicles in accordance with various aspects of the present disclosure. Example 300 includes four vehicles, shown as “MV,” “V1,” “V2,” and “V3.” (which may correspond to vehicles 130 and be referred to herein collectively as “the vehicles”), a base station (e.g., a base station of network 150), and a roadside unit (e.g., a roadside unit of roadside platform 110). In example 300, the vehicles configure a platoon and perform sensor data sharing according to example aspects described herein. Once established within a platoon, each of the vehicles in the platoon are to share sensor data with other vehicles in the platoon. For example, V2 is to share sensor data associated with a characteristic of V2 (e.g., a location, a speed, and/or the like) and/or an environment of V2 so that vehicles V1, V3, and/or MV can obtain information associated with an operation (or movement) of V2 and/or the environment of V2.

As described herein, an environment of a platoon may correspond to an environment that is defined by a sensing range of sensors of the vehicles in the platoon. Correspondingly, an environment of a vehicle may correspond to an environment that is defined by a sensing range of the sensors of that vehicle. In this way, an environment of a vehicle is considered to be within an environment of the platoon.

As described herein, when referring to a vehicle of the platoon performing an action (e.g., receiving information, communicating with another entity, determining a reliability of a sensor system, enabling use of sensor data, using sensor data, and/or the like), it is to be understood that an ECU of the vehicle may be performing the action.

As shown in FIG. 3, and by reference number 310, the vehicles initiate platoon communication and designate a master vehicle. For example, one or more of the vehicles (e.g., MV) may detect that another vehicle (or the other vehicles) in example 300 are traveling in a same direction, at a same speed, and/or within a threshold distance of each other. Accordingly, the vehicles may communicate with one another to form a platoon to enable platoon communication, using any suitable technique. For example, the vehicles may provide vehicle identification information, communication capabilities, location information, speed information, destination information, and/or the like. From those communications and/or information, a master vehicle is selected according to any suitable techniques (e.g., based at least in part on which vehicle that has the best communication capabilities, which vehicle has the best sensor capabilities, which vehicle initiated the platoon communication request, which vehicle is leading the platoon, and/or the like).

In example 300, one of the vehicles, MV, as the lead vehicle, is designated as the master vehicle and the remaining vehicles (V1, V2, and V3) are designated as member vehicles. As described herein, the master vehicle is configured to control communications between the vehicles of the platoon. Additionally, or alternatively, the master vehicle may determine whether another vehicle can join the platoon (e.g., when another vehicle is determined to be traveling in a same direction, at a same speed, and/or is within a threshold distance of one of the vehicles of the platoon) and/or may detect whether one of the member vehicles has left the platoon. Furthermore, the master vehicle may hand-off master vehicle capabilities or responsibilities to one of the member vehicles if, for example, the master vehicle is to leave the platoon (e.g., moves greater than a threshold distance from the member vehicles).

In this way, the vehicles may initiate platoon communications and establish a master vehicle to permit the master vehicle to configure sensor data sharing profiles for the member vehicles based at least in part on vehicle specific information associated with the member vehicles.

As further shown in FIG. 3, and by reference number 320, the member vehicles provide vehicle specific information to the master vehicle. For example, the member vehicles indicate characteristics (e.g., type, range, field of view (relative to direction of travel), resolution, and/or the like) of sensors that are included within respective sensor systems of the member vehicles. Additionally, or alternatively, the member vehicles may provide location and/or speed information to the master vehicle. According to some implementations, the member vehicles may provide information associated with the member vehicles, themselves (e.g., make/model of manufacture, year of manufacture, mileage, and/or the like).

In this way, based at least in part on receiving the vehicle specific information, the master vehicle may determine individual sensor sharing data profiles for the vehicles based at least in part on the vehicle specific information.

As further shown in FIG. 3, and by reference number 330, the master vehicle configures sensor data sharing for the platoon. For example, the master vehicle, for each of the vehicles in the platoon (including the master vehicle), the master vehicle determines sensor data sharing profiles for the vehicles. For example, the master vehicle may determine a classification of the member vehicles for the platoon. The classification may be relative to other members of the platoon, and/or correspond to tiers with respect to which vehicles should share which sensor data or information at which times. For example, the classification may be determined based at least in part on respective sensor capabilities of the vehicles in the platoon, based at least in part on positions of the vehicles within the platoon, and/or the like. As a specific example, as shown in FIG. 3, V3 has a sensor system with sensing capability in two directions (toward the front and rear of V3), while V2 has a sensor system with omnidirectional sensing capability. Accordingly, the master vehicle may determine that a classification for V3 is relatively lower than a classification for V2. According to the classifications, V2V communications with V2 may be given a higher priority within the platoon than V2V communications of V3 (e.g., by allocating more communication bandwidth to V2 during V2V communication, by causing V2 to communicate more often than V3, and/or the like). Based at least in part on the determined classification, the master vehicle may determine (or select) sensor data sharing profiles for the vehicles in the platoon that correspond to the classifications to cause the member vehicles to share data according to the classifications of the member vehicles.

In some aspects, classifications for vehicles and/or corresponding sensor data sharing profiles for use in connection with aspects described herein can be preconfigured (e.g., by a manufacturer) for vehicles capable of using and/or providing V2V communications. Additionally, or alternatively the classifications and/or sensor data sharing profiles can be determined and/or provided by a third-party entity (e.g., a V2V standards committee, a governmental agency, and/or the like). In some implementations, classifications and/or sensor data sharing profiles may be dynamically determined relative to individual characteristics of the specific vehicles within a platoon. In this way, classifications and/or sensor data sharing profiles can be customized (e.g., by the master vehicle) for a particular platoon based at least in part on the characteristics of the platoon and/or characteristics (or sensing capabilities) of the vehicles in the platoon. The classifications and/or sensor data sharing profiles may be configured to reduce redundant generation, distribution, and/or processing of sensor data by the vehicles in the platoon.

As described herein, a sensor data sharing profile for a vehicle may specify a transmission frequency (e.g., every 100 milliseconds (ms), every 300 ms, every 500 ms, and/or the like) associated with the vehicle sharing sensor data with the platoon, a specific type of sensor data (e.g., associated with a specific type of sensor) that is to be shared with the platoon, a specific type of information that is to be shared by the vehicle (e.g., information associated with a particular region of the environment of the vehicle or the environment of the platoon, information associated with particular objects, and/or the like), and/or the like.

Accordingly, the sensor data sharing profiles for each of the member vehicles and the master vehicle may differ according to the vehicle specific information of the vehicles in the platoon. In this way, the master vehicle may determine the sensor data sharing profiles for the member vehicles and provide the sensor data sharing profiles to the member vehicles to cause the member vehicles to share the sensor data according to the respective sensor data sharing profiles.

As further shown in FIG. 3, and by reference number 340, the member vehicles are to share sensor data according to the sensor data sharing profiles. For example, the member vehicles may share data at the specified frequency of the sensor data sharing profile, may share a specific type of sensor data according to the sensor data sharing profile, may share a specific type of information associated with the vehicle and/or an environment of the vehicle, and/or the like. Based at least in part on receiving the sensor data sharing profiles, the member vehicles may configure different sensor sharing message generation rules according to the sensor data sharing profiles. In some implementations, the master vehicle and/or member vehicles, when sharing information, may identify the classification of the member vehicle (e.g., via a classification identifier), so that the other vehicles of the platoon can select which sensor data to use to perform one or more actions. In some implementations, based at least in part on certain characteristics of the member vehicle, as described herein, member vehicles could adjust its sensor sharing operations (e.g., based at least in part on local processing or traffic characteristics, classification identifiers of other member vehicles, types of data received from other vehicles, and/or the like). Furthermore, similar to adjusting the sensor sharing operations, the vehicles may adjust operations associated with the sensors. For example, if a member vehicle is not to share sensor data associated with a particular sensor, the member vehicle may disable or power down that sensor to conserve power and/or resources associated with that sensor.

According to some implementations, one or more of the member vehicles may override certain parameters of a sensor data sharing profile that was provided by the master vehicle. For example, the master vehicle may determine that both V1 and V2 are in a same classification, and, correspondingly, are to share data according to a same sensor data sharing profile. In such a case, the sensor data sharing profile may cause both V1 and V2 to share sensor data that is associated with a same portion of the environment of the platoon (e.g., the portion of the environment that includes both the environment of V1 and the environment of V2). In some implementations, V2 may determine that sharing such sensor data is redundant based at least in part on receiving sensor data associated with a same object or that includes the same information as detected and/or provided by V1. In such cases, V2 may alter a parameter associated with the sensor data sharing profile to reduce the redundant sharing of sensor data associated with the same object and/or information. For example, V2 may reduce a transmission frequency of the sensor data sharing profile, increase periods of time between sharing data associated with a particular object detected by both V1 and V2, increase periods of time between sharing data associated with the same information generated and/or shared by both V1 and V2, and/or the like. In this way, the member vehicles may independently override a parameter of sensor data sharing profile that was provided by the master vehicle. In some implementations, the member vehicle may notify the master vehicle that such a parameter has been overridden (e.g., to permit the master vehicle to adjust the sensor data sharing profile and/or classification for the member vehicle).

In this way, redundant sensor data capture, sharing, and/or processing by the vehicles in the platoon can be reduced according to the characteristics of the vehicles and/or the platoon (e.g., because unnecessary or less reliable sensor data relative to corresponding sensor data from other sources or vehicles is not to be captured, shared, or processed). Accordingly, as described herein, a sensor data sharing system may free up resources that would otherwise be consumed by previous techniques. Accordingly, the sensor data sharing system may improve safety with respect to the vehicles having more available resources during operation (e.g., thus preventing injury, damage to hardware resources or vehicles, and/or the like) and/or avoiding wasting resources associated with sharing unreliable sensor data, as described herein.

As indicated above, FIG. 3 is provided merely as one or more examples. Other examples may differ from what is described with regard to FIG. 3.

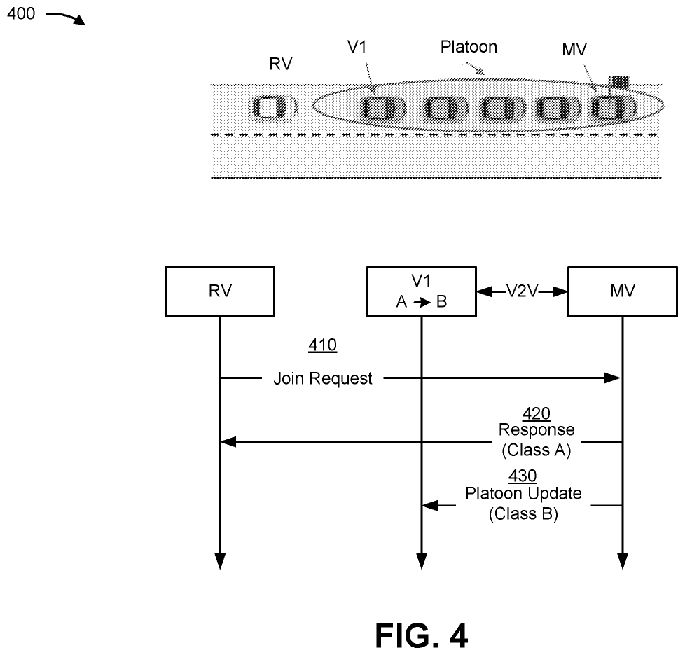

FIG. 4 is a diagram conceptually illustrating an example 400 associated with sensor data sharing between vehicles in accordance with various aspects of the present disclosure. In the example of FIG. 4, a remote vehicle (“RV”) is to join a platoon that includes a member vehicle (“V1”) and a master vehicle (“MV”) of a platoon and a remote vehicle (“RV”) that is joining the platoon. As shown, the remote vehicle is joining the platoon at the rear of the platoon. As further shown in FIG. 4, example 400 includes a call flow between the remote vehicle, the member vehicle, and the master vehicle.

In example 400 of FIG. 4, the master vehicle may determine that the vehicles in the platoon are to be designated with two classifications: class A and class B. Vehicles in the platoon that are determined to be in class A are to receive a first sensor data sharing profile that indicates that the vehicles are to share sensor data every 100 ms and share data associated with a detected object if a speed of the object (e.g., another vehicle, a hazard, a vulnerable roadside unit (VRU), a roadway sign, and/or the like) changes by 0.5 meters per second (m/s) since the last time data associated with the object was shared. Vehicles in the platoon that are determined to be in class B are to receive a second sensor data sharing profile that indicates that the vehicles are to share sensor data every 500 ms and share data associated with a detected object if a speed of the object changes by 2 m/s since the last time data associated with the object was shared. In example 400, the member vehicle is initially in class A so that the member vehicle can frequently share information associated with the rear of the platoon (e.g., while other member vehicles may be in class B so that sharing of data associated with the rear of the platoon is reduced because V1 blocks a view of the rear of the platoon from the other member vehicles of the platoon).

As shown in FIG. 4, and by reference number 410, the remote vehicle may send a request to the master vehicle to join the platoon. For example, the request from the remote vehicle may include a vehicle identifier, a motion state (e.g., speed, location, and/or the like) of the remote vehicle, sensor capabilities of the remote vehicle, data processing capabilities of the remote vehicle, communication capabilities of the remote vehicle, and/or the like. Based at least in part on the request, the master vehicle, as described herein, may respond to the remote vehicle as shown by reference number 420. For example, a response from the master vehicle to the remote vehicle may include that the request has been accepted, a platoon member identifier, platoon information, and a sensor data sharing profile that is determined by the master vehicle based at least in part on the information in the request. More specifically, as shown, due to determining that the remote vehicle is positioned at the rear of the platoon, the master vehicle may indicate that the remote vehicle has been designated as being in class B, and receive the first sensor data sharing profile.

Based at least in part on the remote vehicle joining the platoon and being at the rear of the platoon, the master vehicle may send a platoon update to the member vehicle, as shown by reference number 430. The platoon update may reassign the member vehicle to class B in order to reduce redundancy associated with sharing sensor data that is associated with both the environment of the remote vehicle and the environment of the member vehicle, reduce distribution associated with relative low quality sensor data that is associated with sensing the environment toward the rear of the member vehicle because the remote vehicle is positioned within that space (blocking much of the field of view of the sensor at the rear of the member vehicle), and/or the like. In this way, according to the example 400, of FIG. 4, the redundant sensor sharing is reduced.

As indicated above, FIG. 4 is provided merely as one or more examples. Other examples may differ from what is described with regard to FIG. 4.

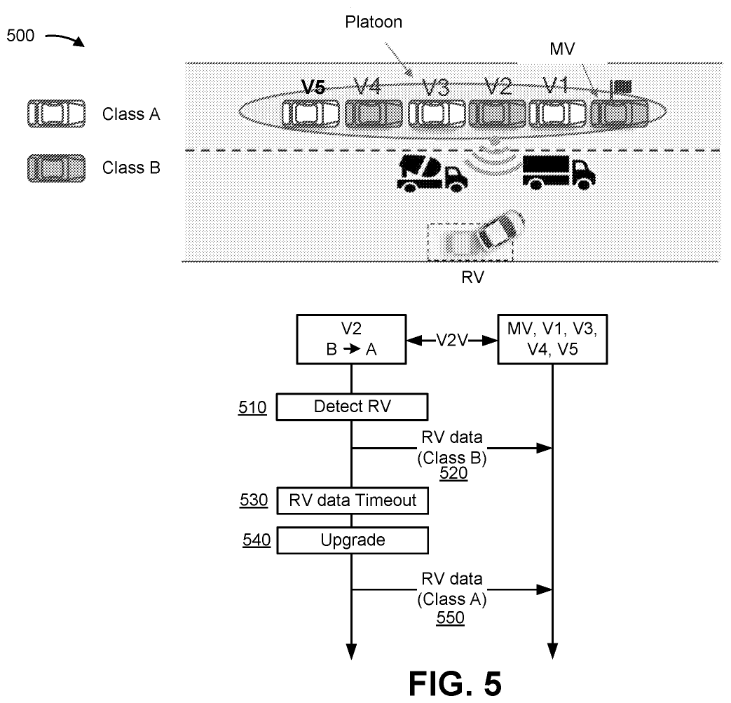

FIG. 5 is a diagram conceptually illustrating an example 500 associated with sensor data sharing between vehicles in accordance with various aspects of the present disclosure. In the example of FIG. 5, a platoon is configured with a master vehicle (“MV”) and member vehicles (“V1,” “V2,” “V3,” “V4,” “V5”). As shown in FIG. 5, MV, V2, and V4 are assigned to Class B (e.g., corresponding to sensor data sharing parameters in connection with first second sensor data sharing profile of example 400) and V1, V3, and V5 are assigned to Class A (e.g., corresponding to sensor data sharing parameters in connection with the second sensor data sharing profile of example 400). A remote vehicle (“RV”) begins to move. As shown, the remote vehicle is blocked from the field of view of V1 and V3 (due to the presence of the trucks), and within the field of view of V2. Example 500 includes a call flow between V2 and the remaining vehicles of the platoon (MV, V1, V3, V4, V5) according to examples described herein.

As shown in FIG. 5, and by reference number 510, V2 detects the remote vehicle. V2 provides remote vehicle detection data according to the transmission parameters of Class B vehicles and/or according to the second sensor data sharing profile, as shown by reference number 520.

As shown by reference number 530, V2 may detect a timeout corresponding to not receiving sensor data that is associated with the remote vehicle (e.g., because the remote vehicle is blocked from view of sensors of the other vehicles). Accordingly, as shown by reference number 540, V2 may adjust a parameter for sharing sensor data associated with RV. For example, V2 may override the parameter in the sensor data sharing profile provided by the master vehicle to increase a frequency of sharing the sensor data, to improve reliability associated with communications involving the sensor data, to reduce latency associated with providing the sensor data, and/or the like. Such an adjustment may be temporary (e.g., only for a duration of time that corresponds to detecting the remote vehicle). As shown by reference number 550, V2 provides the RV data to the remaining vehicles of the platoon according parameters of class A.

In this way, a member vehicle may override a particular parameter of a sensor data sharing profile assigned to the member vehicle to improve sensing capabilities of the platoon, as a whole.

As indicated above, FIG. 5 is provided merely as one or more examples. Other examples may differ from what is described with regard to FIG. 5.

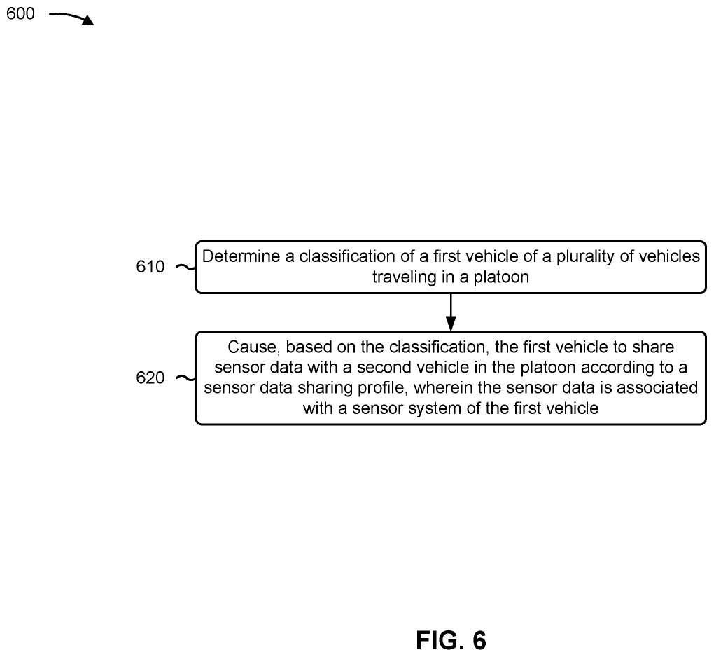

FIG. 6 is a diagram illustrating an example process 600 performed, for example, by a sensor data sharing system, in accordance with various aspects of the present disclosure. Example process 600 is an example where a sensor data sharing system (e.g., a sensor data sharing system of roadside platform 110, a sensor data sharing system of ECU 132, and/or the like) performs operations associated with vehicle to vehicle communication control for vehicles in a platoon.

As shown in FIG. 6, in some aspects, process 600 may include determining a classification of a first vehicle of a plurality of vehicles traveling in a platoon (block 610). For example, the sensor data sharing system (e.g., using computing resource 115, ECU 132, processor 220, memory 230, storage component 240, input component 250, output component 260, communication interface 270, sensor 280 and/or the like) may determine a classification of a first vehicle of a plurality of vehicles traveling in a platoon, as described above.

As further shown in FIG. 6, in some aspects, process 600 may include causing, based at least in part on the classification, the first vehicle to share sensor data with a second vehicle in the platoon according to a sensor data sharing profile, wherein the sensor data is associated with a sensor system of the first vehicle (block 620). For example, the sensor data sharing system (e.g., using computing resource 115, ECU 132, processor 220, memory 230, storage component 240, input component 250, output component 260, communication interface 270, sensor 280 and/or the like) may cause, based at least in part on the classification, the first vehicle to share sensor data with a second vehicle in the platoon according to a sensor data sharing profile, as described above. In some aspects, the sensor data is associated with a sensor system of the first vehicle.

Process 600 may include additional aspects, such as any single aspect or any combination of aspects described below and/or in connection with one or more other processes described elsewhere herein.

In a first aspect, the classification is determined based at least in part on at least one of a position of the first vehicle within the platoon, a sensing characteristic of the sensor system. In a second aspect, alone or in combination with the first aspect, the classification is determined based at least in part on a vehicle to vehicle (V2V) communication received from the first vehicle.

In a third aspect, alone or in combination with one or more of the first and second aspects, the V2V communication includes at least one of a request to join the platoon, sensor information associated with a sensory system of the first vehicle that includes the sensor system, or a location of the first vehicle.

In a fourth aspect, alone or in combination with one or more of the first through third aspects, the sensor data sharing profile is selected from a plurality of stored sensor data sharing profiles that are configured to control sensor data sharing between the plurality of vehicles.

In a fifth aspect, alone or in combination with one or more of the first through fourth aspects, the sensor data sharing profile identifies at least one of a transmission frequency associated with the first vehicle transmitting the sensor data to the second vehicle, a sensor data indicator that identifies whether to share a type of sensor data of the sensor system, or information type indicator that identifies whether to share a type of information that is associated with the sensor data.

In a sixth aspect, alone or in combination with one or more of the first through fifth aspects, causing the first vehicle to share the sensor data may include at least one of: providing an identifier of the classification to the first vehicle or providing the sensor data sharing profile to the first vehicle.

In a seventh aspect, alone or in combination with one or more of the first through sixth aspects, causing the first vehicle to share the sensor data may include detecting an event associated with the platoon; and causing the first vehicle to share the sensor data based at least in part on the event.

In an eighth aspect, alone or in combination with one or more of the first through seventh aspects, the sensor data is first sensor data, and the sensor data sharing profile is a first sensor data sharing profile, and process 600 may include determining a characteristic of the second vehicle; and causing, based at least in part on the second characteristic, the second vehicle to share second sensor data with the first vehicle according to a second sensor data sharing profile that is different from the first sensor data sharing profile, wherein the second sensor data is associated with a sensor of the second vehicle.

In a ninth aspect, along or in combination with one or more of the first through eight aspects, the sensor data sharing profile is selected from a plurality of sensor data sharing profiles that are available to control sensor data sharing between the plurality of vehicles. In a tenth aspect, along or in combination with one or more of the first through ninth aspects, the sensor data sharing system is collocated with the second vehicle.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

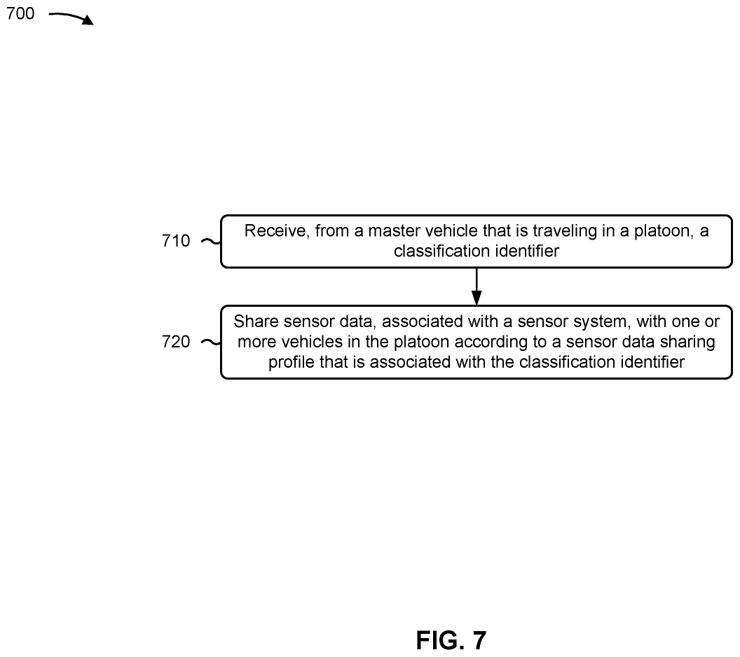

FIG. 7 is a diagram illustrating an example process 700 performed, for example, by a sensor data sharing system, in accordance with various aspects of the present disclosure. Example process 700 is an example where a sensor data sharing system (e.g., a sensor data sharing system of roadside platform 110, a sensor data sharing system of ECU 132, and/or the like) performs operations associated with vehicle to vehicle communication control for vehicles in a platoon.

As shown in FIG. 7, in some aspects, process 700 may include receiving, from a master vehicle that is traveling in a platoon, a classification identifier (block 710). For example, the sensor data sharing system (e.g., using computing resource 115, ECU 132, processor 220, memory 230, storage component 240, input component 250, output component 260, communication interface 270, sensor 280 and/or the like) may receive, from a master vehicle that is traveling in a platoon, a classification identifier, as described above.

As further shown in FIG. 7, in some aspects, process 700 may include sharing sensor data, associated with a sensor system, with one or more vehicles in the platoon according to a sensor data sharing profile that is associated with the classification identifier (block 720). For example, the sensor data sharing system (e.g., using computing resource 115, ECU 132, processor 220, memory 230, storage component 240, input component 250, output component 260, communication interface 270, sensor 280 and/or the like) may share sensor data, associated with a sensor system, with one or more vehicles in the platoon according to a sensor data sharing profile that is associated with the classification identifier, as described above.

Process 700 may include additional aspects, such as any single aspect or any combination of aspects described below and/or in connection with one or more other processes described elsewhere herein.

In a first aspect, the characteristic relates to at least one of a position of another vehicle in the platoon that has a higher sensing capability than the sensor system and that shares data according to the sensor data sharing profile, or an object moving within a field of view of a sensor of the sensor system. In a second aspect, alone or in combination with the first aspect, the sensor data sharing profile is received from the master vehicle.

In a third aspect, alone or in combination with one or more of the first and second aspects, the parameter relates to at least one of a transmission frequency associated with sharing the sensor data, whether to share a type of sensor data of the sensor system, or whether to share a type of information that is associated with the sensor data.

In a fourth aspect, alone or in combination with one or more of the first through third aspects, the parameter is overridden without notifying the master vehicle.

In a fifth aspect, alone or in combination with one or more of the first through fourth aspects, the parameter is overridden until the characteristic is no longer detected.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based at least in part on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
determining, by a device, a classification of a first vehicle of a plurality of vehicles traveling in a platoon; and
causing, by the device and based at least in part on the classification, the first vehicle to share sensor data with a second vehicle in the platoon according to a sensor data sharing profile,
wherein the sensor data is associated with a sensor system of the first vehicle.

2. The method of claim 1, wherein the classification is determined based at least in part on at least one of:
a position of the first vehicle within the platoon,
a sensing characteristic of the sensor system.

3. The method of claim 1, wherein the classification is determined based at least in part on a vehicle to vehicle (V2V) communication received from the first vehicle.

4. The method of claim 3, wherein the V2V communication includes at least one of:
a request to join the platoon,
sensor information associated with a sensory system of the first vehicle that includes the sensor system, or
a location of the first vehicle.

5. The method of claim 1, wherein the sensor data sharing profile is selected from a plurality of stored sensor data sharing profiles that are configured to control sensor data sharing between the plurality of vehicles.

6. The method of claim 1, wherein the sensor data sharing profile identifies at least one of:
a transmission frequency associated with the first vehicle transmitting the sensor data to the second vehicle,
a sensor data indicator that identifies whether to share a type of sensor data of the sensor system, or
information type indicator that identifies whether to share a type of information that is associated with the sensor data.

7. The method of claim 1, wherein causing the first vehicle to share the sensor data comprises at least one of:
providing an identifier of the classification to the first vehicle, or providing the sensor data sharing profile to the first vehicle.

8. The method of claim 1, wherein causing the first vehicle to share the sensor data comprises:
detecting an event associated with the platoon; and
causing the first vehicle to share the sensor data based at least in part on the event.

9. The method of claim 1, wherein the sensor data is first sensor data, and the sensor data sharing profile is a first sensor data sharing profile, the method further comprising:
determining a characteristic of the second vehicle; and
causing, based at least in part on the second characteristic, the second vehicle to share second sensor data with the first vehicle according to a second sensor data sharing profile that is different from the first sensor data sharing profile,
wherein the second sensor data is associated with a sensor of the second vehicle.

10. A device, comprising:
a memory; and
one or more processors operatively coupled to the memory, the memory and the
one or more processors configured to:
determine a classification of a first vehicle of a plurality of vehicles traveling in a platoon; and
cause, based at least in part on the classification, the first vehicle to share sensor data with a second vehicle in the platoon according to a sensor data sharing profile,
wherein the sensor data is associated with a sensor system of the first vehicle.

11. The device of claim 10, wherein the classification is determined based at least in part on at least one of:
a position of the first vehicle within the platoon, or
a sensing characteristic of the sensor system.

12. The device of claim 10, wherein the classification is determined based at least in part on a vehicle to vehicle (V2V) communication received from the first vehicle.

13. The device of claim 10, wherein the sensor data sharing profile is selected from a plurality of sensor data sharing profiles that are available to control sensor data sharing between the plurality of vehicles.

14. The device of claim 10, wherein the sensor data sharing profile identifies at least one of:
a transmission frequency associated with the first vehicle transmitting the sensor data to the second vehicle,
a sensor data indicator that identifies whether to share a type of sensor data of the sensor system, or
information type indicator that identifies whether to share a type of information that is associated with the sensor data.

15. The device of claim 10, wherein causing the first vehicle to share the sensor data comprises at least one of:
provide an identifier of the classification to the first vehicle, or
provide the sensor data sharing profile to the first vehicle.

16. The device of claim 10, wherein the sensor data is first sensor data, and the sensor data sharing profile is a first sensor data sharing profile, the device wherein the one or more processors are further configured to:
determine a characteristic of the second vehicle; and
cause, based at least in part on the second characteristic, the second vehicle to share second sensor data with the first vehicle according to a second sensor data sharing profile that is different from the first sensor data sharing profile,
wherein the second sensor data is associated with a sensor of the second vehicle.

17. The device of claim 10, wherein the device is collocated with the second vehicle.

18. The device of claim 17, wherein the second vehicle is a lead vehicle of the platoon and the first vehicle is traveling behind the second vehicle.

19. A non-transitory computer-readable medium storing one or more instructions, the one or more instructions comprising:
one or more instructions that, when executed by one or more processors of a device, cause the one or more processors to:
receive, from a master vehicle that is traveling in a platoon, a classification identifier;
share sensor data, associated with a sensor system, with one or more vehicles in the platoon according to a sensor data sharing profile that is associated with the classification identifier;
detect a characteristic associated with the platoon; and
override a parameter associated with the sensor data sharing profile to adjust sensor data sharing with the one or more vehicles.

20. The non-transitory computer-readable medium of claim 19, wherein the characteristic relates to at least one of:
another vehicle in the platoon that has a higher sensing capability than the sensor system and that shares data according to the sensor data sharing profile, or
an object moving within a field of view of a sensor of the sensor system.

21. The non-transitory computer-readable medium of claim 19, wherein the sensor data sharing profile is received from the master vehicle.

22. The non-transitory computer-readable medium of claim 19, wherein the parameter relates to at least one of:
a transmission frequency associated with sharing the sensor data,
whether to share a type of sensor data of the sensor system, or
whether to share a type of information that is associated with the sensor data.

23. The non-transitory computer-readable medium of claim 19, wherein the parameter is overridden without notifying the master vehicle.

24. The non-transitory computer-readable medium of claim 19, wherein the parameter is overridden until the characteristic is no longer detected.

25. An apparatus for wireless communication, comprising:
means for receiving, from a master vehicle that is traveling in a platoon, a classification identifier;
means for sharing sensor data, associated with a sensor system, with one or more vehicles in the platoon according to a sensor data sharing profile that is associated with the classification identifier;
means for detecting a characteristic associated with the platoon; and
means for overriding a parameter associated with the sensor data sharing profile to adjust sensor data sharing with the one or more vehicles.

26. The apparatus of claim 25, wherein the characteristic relates to at least one of:
another vehicle in the platoon that has a higher sensing capability than the sensor system and that shares data according to the sensor data sharing profile, or
an object moving within a field of view of a sensor of the sensor system.

27. The apparatus of claim 25, wherein the sensor data sharing profile is received from the master vehicle.

28. The apparatus of claim 25, wherein the parameter relates to at least one of:
a transmission frequency associated with sharing the sensor data,
whether to share a type of sensor data of the sensor system, or
whether to share a type of information that is associated with the sensor data.

29. The apparatus of claim 25, wherein the parameter is overridden without notifying the master vehicle.

30. The apparatus of claim 25, wherein the parameter is overridden until the characteristic is no longer detected.
